(19) United States
(12) Patent Application Publication
(10) Pub. No.: US 2025/0168565 A1
(43) Pub. Date: May 22, 2025

(54) HEADBAND AND HEADPHONES

(71) Applicant: Anker Innovations Technology Co., Ltd., Changsha (CN)

(72) Inventor: Wenchao Tang, Shenzhen (CN)

(21) Appl. No.: 18/928,571

(22) Filed: Oct. 28, 2024

(30) Foreign Application Priority Data
Nov. 17, 2023 (CN) 202323116454.9

(51) Int. Cl. H04R 5/033; H04R 1/10

(52) U.S. Cl. CPC H04R 5/0335; H04R 1/1008; H04R 1/1033; H04R 1/1066

(57) ABSTRACT

The present disclosure describes a headband and headphones. The headband includes a frame and two folding assemblies. The frame is in an arc shape overall and covers a wearing space. The two folding assemblies are respectively connected to two ends of the frame. Each of the folding assemblies comprises a pivot, an arm and a second pivot. The pivot is connected to the frame and configured to rotate relative to the frame. The arm is connected to an end of the first pivot, and is configured to swing toward or away from the wearing space to switch between a folded state and an unfolded state. The second pivot is connected to the arm and configured to rotate relative to the arm.

### CROSS-REFERENCE TO RELATED APPLICATION

The present disclosure claims priority of the Chinese Patent Application No. 202323116454.9, filed on Nov. 17, 2023 before the China National Intellectual Property Administration, entitled “headband and headphones”, which is incorporated herein by reference in its entirety.

### FIELD

The present disclosure relates to the field of headphones, particularly to a headband and headphones.

### BACKGROUND

Head-mounted devices such as headphones are popular among users because of their convenience in wearing. However, head-mounted devices are generally large in size, which causes them to occupy more storage space in storage and be inconvenient to carry.

### SUMMARY

The present disclosure provide a connector and headphones, which can reduce the space volume of the headphones in storage and make the headphones more convenient to carry.

In a first aspect, the present disclosure provides a connector (e.g., a headband) comprising a frame and two folding assemblies. The frame is in an arc shape overall and defines a wearing space configured to fit with a wearing part in a worn state of the connector, and the two folding assemblies are respectively connected to two ends of the frame. The folding assembly comprises a rotating member, a swinging member and a connecting member, the rotating member is connected to the frame, and the rotating member can rotate relative to the frame. The swinging member is swingably connected to an end of the rotating member away from the frame, and the swinging member is configured to swing toward or away from the wearing space to switch between a folded state and an unfolded state. The connecting member is configured to connect the headphone unit, is connected to the swinging member, and is configured to rotate relative to the swinging member.

In a second aspect, an example of the present disclosure provides headphones comprising two headphone units (e.g., speakers, speaker drives, earmuffs) and the headband, wherein one of the headphone units is connected to the connecting member of one of the folding assemblies, and the other of the headphone units is connected to the connecting part of the other of the folding assemblies.

Based on the above examples, when the headphones comprising the above connector are not used, the connecting member may be rotated around an extension direction of the swinging member first, driving the headphone unit connected to the connecting member to rotate at a certain angle, and then an end of the swinging member away from the rotating member is rotated into the wearing space, driving the connecting member and the headphone unit to rotate into the wearing space, so that the headphone unit is folded and stored in the wearing space. After rotating the swinging member, the rotating member may be rotated a certain angle relative to the frame, so that the headphone unit has an angle relative to a plane where the frame is in. In this way, a space volume of the headphones in storage can be reduced. Compared with the headphones in the related art not to be deformed or folded, the headphones with the connector of the example of the present disclosure occupy less space and are more convenient to carry. Moreover, a projection of the headphone unit on the plane where the frame is in is smaller, which effectively reduces or can eliminate a force on the connector and is conducive to maintaining the folded state.

### BRIEF DESCRIPTION OF THE DRAWINGS

In order to more clearly illustrate the disclosure or technical solutions in the related art, drawings that need to be used in description of the examples or the related art are briefly introduced below, and it will be apparent to those of ordinary skill in the art that the drawings in the following description are only some examples of the invention, and other drawings may be obtained in accordance with structures shown in these drawings without inventive work.

FIG. 1 is a structure diagram of headphones according to an example of the present disclosure;

FIG. 2 is a cross-sectional structure diagram of headphones according to another example of the present disclosure;

FIG. 3 is an enlarged structure diagram of area A in FIG. 2;

FIG. 4 is a structure diagram of headphones according to an example of the present disclosure in an unfolded state;

FIG. 5 is a structure diagram of the headphones in FIG. 4 after a connecting member thereof is rotated;

FIG. 6 is a structure diagram of the headphones in FIG. 5 after a swinging member thereof is rotated;

FIG. 7 is a structure diagram of the headphones in FIG. 6 after a rotating member thereof is rotated;

FIG. 8 is a structure diagram of a connector of the headphones in FIG. 7 in a folded state;

FIG. 9 is a structure diagram of the headphones in FIG. 4 in a folded state;

FIG. 10 is a top view of the structure of the headphones in FIG. 9;

FIG. 11 is a cross-sectional diagram of a partial structure of headphones according to an example of the present disclosure;

FIG. 12 is an enlarged diagram of area B in FIG. 11;

FIG. 13 is a cross-sectional diagram of the partial structure of the headphones in FIG. 11 from another viewing angle;

FIG. 14 is a partial structure diagram of headphones according to another example of the present disclosure;

FIG. 15 is a structure diagram a frame according to an example of the present disclosure;

FIG. 16 is an exploded structure diagram of the frame in FIG. 15;

FIG. 17 is an enlarged structure diagram of area C in FIG. 16.

### DESCRIPTION OF REFERENCE NUMERALS

1000: headphones; 100: connector; 1: frame; 1a: wearing space; 10: frame body; 10a: connecting mechanism; 10b: first clamping mechanism; 10c: second clamping mechanism; 11: first joint structure 111: joint body; 1111: peg; 1111a: first connecting hole; 1111b: fourth annular groove; 1113: rabbet; 1113a: second connecting hole; 1115: mounting member; 113: elastic buffer; 115: rotating shaft; 13: second joint structure; 13a: movement channel; 13b: guide groove; 15: memory metal strip; 30: sliding member: 31: first protrusion; 33: second protrusion; 2: folding assembly; 40: rotating member; 41: connecting groove; 43: avoidance gap; 50: swinging member; 60: connecting member; 70; rotating connection assembly: 70a: mounting annular groove; 71: socket; 71a: connecting channel; 71b: slide groove; 71c: third annular groove; 73; plug; 731: connecting portion 733: inserting shaft portion; 733a: first annular groove; 733b: second annular groove; 735: limiting portion; 75: arc-shaped hooping member; 90: damping member; 300: headphone unit; 301: earmuff; S: swing shaft.

Achievement of the object, functional features and advantages of the disclosure will be further described in combination with examples and with reference to the accompanying drawings.

### DETAILED DESCRIPTION

The present disclosure will be described in further detail below with reference to the accompanying drawings in order to provide a clearer understanding of the purpose, technical solution and advantages of the present disclosure.

When the following description refers to the drawings, the same numbers in different drawings represent the same or similar elements unless otherwise indicated. The implementations described in the following exemplary examples do not represent all implementations consistent with the present disclosure. Rather, they are merely examples of the apparatus and method consistent with some aspects of the present disclosure as detailed in the appended claims.

It should be understood that, the terms “first”, “second”, and the like are used for descriptive purposes only and should not be construed as indicating or implying relative importance in the description of the present disclosure. The specific meanings of the above terms in the disclosure may be understood in specific circumstances by those skilled in the art. Moreover, “a plurality of” means two or more unless otherwise stated in the description of the disclosure. “And/or” describes an associative relationship and indicates that there may be three relationships. For example, A and/or B may mean: three cases of A alone, A and B at the same time, and B alone. The character “/” generally indicates that the former and latter associated objects are in an “or” relationship.

Unless defined otherwise, all technical and scientific terms used herein have the same meaning as commonly understood by one of ordinary skill in the art to which this disclosure belongs. The terms used in the description are only for the purpose of describing specific examples and are not taken as a limitation of the present disclosure. As used herein, the term “and/or” includes any and all combinations of one or more related listed items.

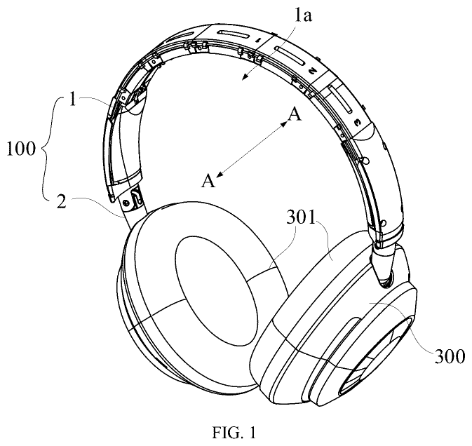

In order to solve the problem that head-mounted devices are generally large in size, occupy large storage space in storage, and are inconvenient to carry, an aspect of the present disclosure describes headphones 1000. In FIG. 1, the headphones 1000 include two headphone units 300 (e.g., two speakers in two respective earcups) and a connector 100 (e.g., headband, support band). The two headphone units 300 are respectively provided at two ends of the connector 100. The connector 100 connects the two headphone units 300 and provides structural support for the headphones 1000. When the headphones 1000 are worn (e.g., by a user), the two headphone units 300 are respectively located near two ears of a user. The headphone units 300 have sound outlets configured to emit sound to an external auditory canal of the user. In an example of the present disclosure, the headphones 1000 have an unfolded state for wearing and one or more folded states for storage. In a folded state, the headphones 1000 occupy smaller space and are more convenient to carry.

Referring to FIG. 1, the present disclosure describes a connector 100 including a frame 1 and two sets of folding assemblies 2. The frame 1 is in an arc shape overall, and the two sets of folding assemblies 2 are respectively connected to two ends of the frame 1. It can be understood that, taking the connector 100 applied to the head-mounted headphones 1000 as an example, when a user wears the headphones 1000 on the head, the connector 100 is in a worn state, the arc-shaped frame 1 encloses a wearing space 1a (e.g., a headspace) in the middle, and part of the user's head (wearing part) is located in the wearing space 1a to fit the connector 100. The folding assembly 2 is configured to mount (e.g., connect) the headphone unit 300 on the connector 100, and the connector 100 can fix the headphone unit 300 on the user's head. The frame 1 is a main structure of the connector 100 and is configured to provide a mounting position and support for components such as the folding assembly 2. The arc-shaped frame 1 can fit the user's head when the headphones 1000 are worn, thereby achieving a good wearing effect. In order to further improve fit and wearing comfort, the headphone unit 300 is provided with an earmuff 301 (e.g., earcup, earpad) on a side thereof with the sound outlet. The earmuff 301 is configured to fit the user's ear in the worn state.

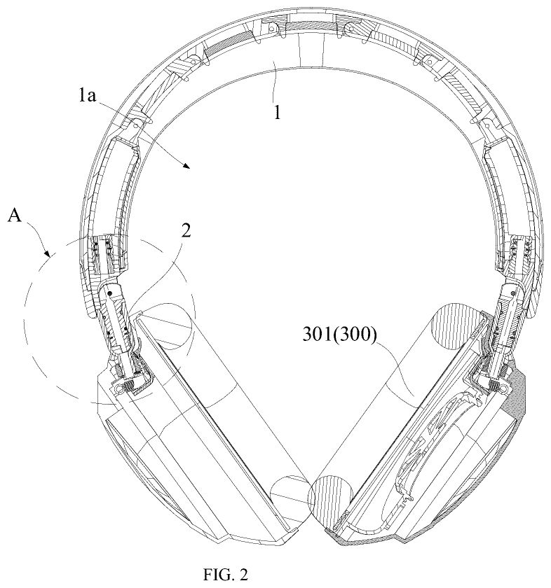

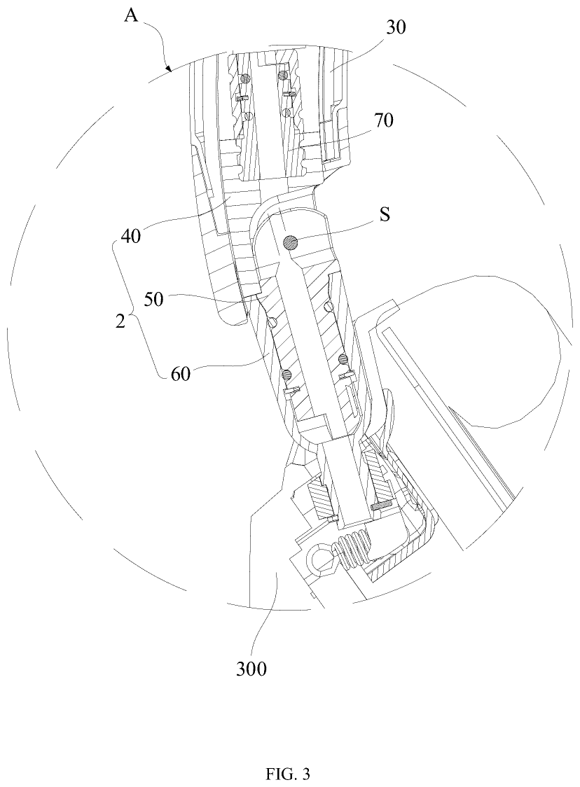

Referring to FIG. 2 and FIG. 3, the folding assembly 2 may include a rotating member 40 (e.g., a rotating device such as a hinge or pivot), a swinging member 50 (e.g., a swivel joint, a movable arm, a hinged arm, an adjustable arm), and a connecting member 60 (e.g., a pivot, a rotating connector, a hinge). The rotating member 40 is connected to an end of the frame 1 and can rotate relative to the frame 1. The swinging member 50 extends in a direction away from the rotating member 40 and is substantially in a rod shape. The swinging member 50 is swingably connected to an end of the rotating member 40 away from the frame 1 via a swing shaft S, and an axis of the swing shaft S is set parallel to a width direction AA shown in FIG. 1. When swinging around the swing shaft 5, an end of the swinging member 50 away from the rotating member 40 can swing into the wearing space 1a or away from the wearing space 1a to switch between the folded state and the unfolded state. The swinging member 50 extends in a direction away from the rotating member 40. The connecting member 60 is configured to connect the headphone unit 300 and the swinging member 50, and can rotate relative to the swinging member 50.

For example, the rotating member 40 is configured to connect the swinging member 50 and the connecting member 60 to the frame 1, the swinging member 50 is configured to connect the rotating member 40 and the connecting member 60. The connecting member 60 is configured to connect the headphone unit 300 of the headphones 1000. As shown in FIG. 3, the connector 100 is in use. For example, when the connector 100 is worn on the head, the frame 1 and the folding assembly 2 are both in an unfolded state, at which time the space volume occupied by the connector 100 is large.

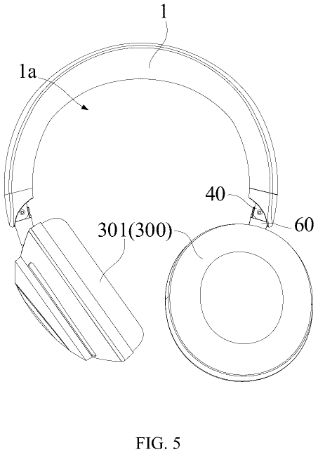

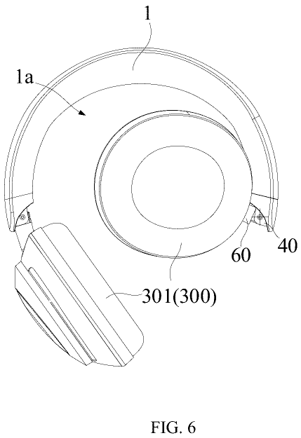

In the example of the present disclosure, when the headphones 1000 with the above connector 100 are not used, as shown in FIGS. 3 to 5, taking the folding assembly 2 located at one end of the frame 1 as an example, the connecting member 60 is configured to rotate relative to the swinging member 50 to drive the headphone unit 300 connected to the connecting member 60 to rotate a certain angle, and an orientation of the sound outlet of the headphone unit 300 is parallel or approximately parallel to the width direction AA shown in FIG. 1. Referring to FIGS. 3, 5 and 6, the end of the swinging member 50 away from the rotating member 40 is rotated around the swing shaft S toward the inside of the connector 100 (e.g., the wearing space 1a), to drive the connecting member 60 and the headphone unit 300 to rotate into the wearing space 1a, so as to fold and store the headphone unit 300 in the wearing space 1a. The two headphone units 300 may overlap each other in the width direction AA of the connector 100, and the headphones 1000 are in a first folded state. In this way, the space volume of the headphones 1000 in storage can be reduced. Compared with the headphones 1000 in the related art not to be deformed or folded, the headphones 1000 with the connector 100 of the example of the present disclosure occupy less space and are more convenient to carry.

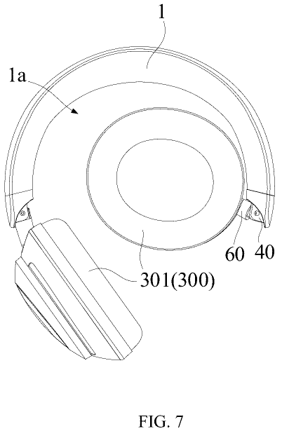

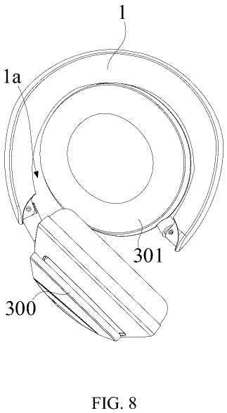

If the volume of the headphone unit 300 is large, after merely the swinging member 50 and the connecting member 60 are rotated a certain angle, the headphone unit 300 exerts a force on the connector 100 to resist tightening thereof. When the connector 100 is placed on a horizontal plane, the force is in the horizontal plane and acts on the two ends of the connector 100 and is provided away from the inner area defined by the connector 100, which is not conducive to maintaining the folded state. To this end, in an example of the present disclosure, as shown in FIGS. 7 and 8, after rotating the swinging member 50, the rotating member 40 can be rotated a certain angle relative to the frame 1, so that the headphone unit 300 has an angle relative to a plane where the frame 1 is in.

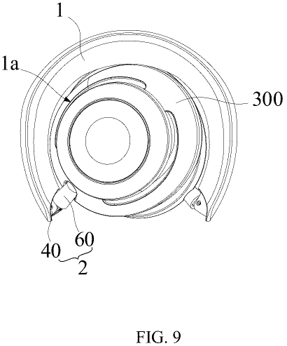

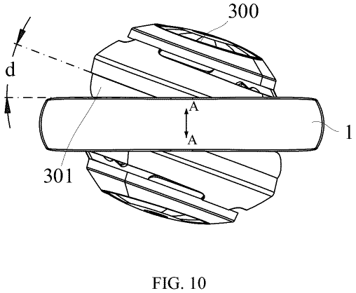

It can be understood that, assuming that the rotating member 40 at one end of the frame 1 rotates clockwise around the extension direction of the frame 1, the rotating member 40 at the other end of the frame 1 rotates counterclockwise around the extension direction of the frame 1, so that sides of the two headphone units 300 with the sound outlets face each other, and the earmuffs 301 of the two headphone units 300 may be provided in contact, forming a second folded state as shown in FIGS. 9 and 10.

If the above second folded state is taken as a storage state of the headphones 1000 according to the example of the present disclosure, the swinging member 50 is in a folded state in the storage state, at which time the headphone unit 300 is in the wearing space 1a. By rotating the rotating member 40 and the connecting member 60, the sides of the two headphone units 300 with the sound outlets face each other, the earmuffs 301 of the two headphone units 300 are close to each other, and the orientations of the sound outlets of the two headphone units 300 are set at an acute angle to the width direction AA shown in FIG. 1 (e.g., the headphone units 300 are tilted relative to the frame 1).

In this way, a projection of the headphone unit 300 on the plane where the frame 1 is located is smaller, which effectively reduces or can eliminate a force of the headphone unit 300 on the connector 100, is conducive to maintaining the folded state of the headphones 1000, and is conducive to making the headphones 1000 have a smaller volume in storage.

The headphones 1000 of the example of the present disclosure can also have a third folded state, and only the end of the swinging member 50 away from the rotating member 40 is rotated into the wearing space 1a to drive the connecting member 60 and the headphone unit 300 to rotate into the wearing space 1a, so that each headphone unit 300 can be folded and stored in the wearing space 1a. The sides of the two headphone units 300 having the sound outlets are arranged opposite to each other (e.g., back-to back, the sound outlets are not facing each other), the earmuffs 301 of the two headphone units 300 are facing away from each other, and the orientation of the sound outlet of the headphone unit 300 intersects with or is in a different plane from the width direction AA of the frame 1.

It can be understood that when the connector 100 in the present disclosure is applied to the headphones 1000, the headphones 1000 can have multiple folded states including but not limited to the above three states, and the user can flexibly and conveniently select the folded state of the headphones 1000 as needed.

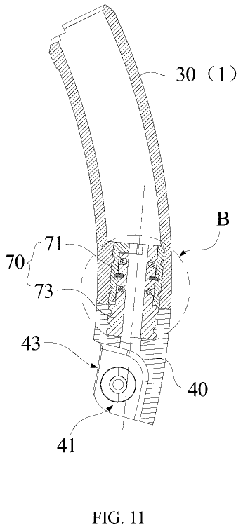

Referring to FIG. 11, in some examples of the present disclosure, the connector 100 further includes a rotating connection assembly 70. The rotating connection assembly 70 may include a socket 71 and a plug 73 fitting with each other, the socket 71 is sleeved on the plug 73, and one of the socket 71 and the plug 73 can rotate relative to the other. One of the rotating member 40 and the frame 1 may be connected to the socket 71, and the other may be connected to the plug 73, so that the rotating member 40 can rotate relative to the frame 1.

For example, to facilitate production and processing, the socket 71 and the plug 73 can be produced separately, assembled, and then assembled to the frame 1 and the rotating member 40. Alternatively, the socket 71 and the plug 73 can be connected to the frame 1 and the rotating member 40 respectively, and then fitted and assembled. The socket 71 and the plug 73 may also be integrally formed with the frame 1 and the rotating member 40 respectively, and this example of the present disclosure does not limit this. In order to ensure a neat appearance of the connector 100, the frame 1 is provided with a first groove configured to accommodate the socket 71, and the socket 71 can be provided in the first groove by means of snap connection, bonding, and the like. Similarly, the rotating member 40 is provided with a second groove configured to accommodate the plug 73, and the plug 73 can be provided in the second groove by means of snap connection, bonding, and the like. Thus, the rotating member 40 can rotate relative to the frame 1 by mutual rotation between the socket 71 and the plug 73. Both the socket 71 and the plug 73 may be roughly rod-shaped and thus have their own axes. The relative rotation between the two refers to rotation of one of the socket 71 and the plug 73 relative to the other around its own axis.

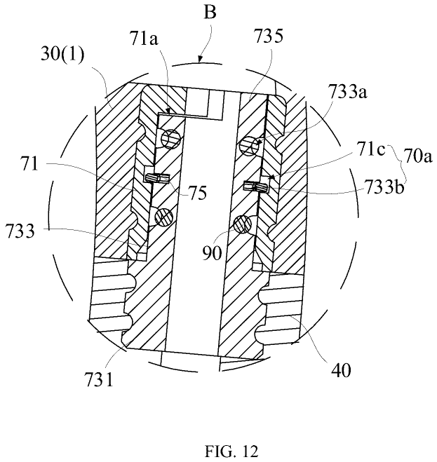

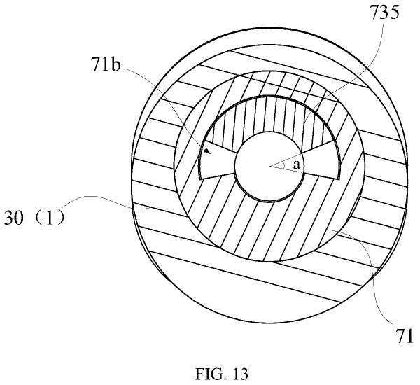

Referring to FIGS. 12 and 13, the socket 71 has a connecting channel 71a, into which the plug 73 partially extends, and an inner wall of which is provided with an arc-shaped slide groove 71b extending along the circumference of the connecting channel 71a. The part of the plug 73 extending into the connecting channel 71a has a limiting portion 735 slidably provided in the slide groove 71b and can be abutted and limited by the inner side wall of one end of the slide groove 71b.

For example, one end of the socket 71 is provided with a wire passing opening connected to the connecting channel 71a for wires electrically connected to the headphone unit 300 to pass through, and the plug 73 is hollow and forms a wire passing channel which is connected to the wire passing opening. An end of the socket 71 is provided with a first boss extending into the wire passing opening, and the first boss and the rest of the inner circumference of the wire passing opening define the slide groove 71b surrounding the wire passing channel. An end of the plug 73 is provided with a second boss extending along an extension direction of the plug 73 (e.g., formed as the limiting portion 735), thereby forming a height difference from the rest cross-section of the end of the plug 73 to extend into the slide groove 71b. In order to reduce shielding of the wire passing channel, the cross section of the second boss may extend in an arc shape.

It can be understood that a central angle occupied by the limiting portion 735 is smaller than a central angle occupied by the slide groove 71b, so that when the plug 73 rotates around the socket 71, inner side walls at both ends of the slide groove 71b can abut and limit movement of the limiting portion 735. For example, when the limiting portion 735 abuts against an inner side wall of a first end of the slide groove 71b, the rotating member 40 is located at a first preset position. When the limiting portion 735 abuts against an inner side wall of a second end of the slide groove 71b, the rotating member 40 is located at a second preset position. When rotating from the first preset position to the second preset position, the rotating member 40 rotates at an angle a relative to the frame 1 (e.g., 15°≤a≤35°).

In some examples, when the limiting portion 735 is located in a middle section of the slide groove 71b, the rotating member 40 is located in the first preset position; and when the limiting portion 735 abuts against the inner side wall of one end of the slide groove 71b, the rotating member 40 is located in the second preset position, so that the rotating member 40 can rotate clockwise or counterclockwise to switch from the first preset position to the second preset position, providing more diverse folding styles.

Referring to FIG. 12, the plug 73 may include a connecting portion 731, an inserting shaft portion 733 (e.g., an inserting shaft) and a limiting portion 735 (e.g., a stopper) which are connected in sequence, wherein the inserting shaft portion 733 and the limiting portion 735 extend into the connecting channel 71a, and the connecting portion 731 is configured to connect with the rotating member 40 or the connecting member 60.

Among them, an outer circumferential wall of the inserting shaft portion 733 and the inner wall of the connecting channel 71a fit to define a first annular groove 733a, and the first annular groove 733a extends along the circumference of the inserting shaft portion 733. The rotating connection assembly 70 further includes an annular damping member 90 filled in the first annular groove 733a. For example, part of the outer circumferential wall of the inserting shaft portion 733 is circumferentially recessed to form a first annular groove 733a with the inner wall of the connecting channel 71a. Additionally or alternatively, part of the inner wall of the connecting channel 71a is circumferentially recessed to form a first annular groove 733a with the inner wall of the connecting channel 71a. Part of the inner wall of the connecting channel 71a and the outer circumferential wall of the inserting shaft portion 733 may both be recessed to fit and form the first annular groove 733a.

In the example of the present disclosure, the damping member 90 may be made of an elastic rubber material to well fill the first annular groove 733a. When the plug rotates relative to the socket 71, the damping member 90 rubs against an inner wall of the first annular groove 733a (e.g., part of the inner wall of the connecting channel 71a and part of the inner wall of the connecting channel 71a). When the two stop rotating relative to each other, the friction force provided by the damping member 90 can keep the plug and the socket 71 in the state before stopping rotation, thereby playing a positioning role.

Further, referring to FIG. 12, the outer circumferential wall of the inserting shaft portion 733 is provided with a second annular groove 733b, and the inner wall of the connecting channel 71a is provided with a third annular groove 71c. The second annular groove 733b is laterally connected to the third annular groove 71c to form a mounting annular groove 70a. The mounting annular groove 70a extends along the circumference of the inserting shaft portion 733. The rotating connection assembly 70 further includes an arc-shaped hooping member 75 (e.g., a clamp, a lock), provided in the mounting annular groove 70a, so that the arc-shaped hooping member 75 is partially embedded in the plug and partially embedded in the socket 71. Therefore, when the plug moves along its own axis relative to the socket 71, the arc-shaped hooping member 75 can limit relative movement of the two to prevent the plug from detaching from the socket 71.

Specifically, the arc-shaped hooping member 75 is an elastic arc-shaped hoop, and a depth of the second annular groove 733b is greater than a width of the arc-shaped hooping member 75. During assembly, the arc-shaped hooping member 75 is first embedded in the second annular groove 733b, and elastically deformed so as to be completely immersed in the second annular groove 733b, so that the inserting shaft portion 733 can be inserted into the connecting channel 71a. As the inserting shaft portion 733 moves in the connecting channel 71a, the inner wall of the connecting channel 71a abuts against the arc-shaped hooping member 75. When the second annular groove 733b is aligned and connected with the third annular groove 71c to form the mounting annular groove 70a, the arc-shaped hooping member 75 pops out and partially enters the third annular groove 71c to be partially embedded into the inner wall of the connecting channel 71a.

In an example, in order to ensure the positioning effect, two first annular grooves 733a are respectively provided on two sides of the mounting annular groove 70a, and the two damping members 90 are respectively provided in the two first annular grooves 733a.

As described above, in the example of the present disclosure, rotation of the rotating member 40 relative to the frame 1 is achieved by rotating the connecting assembly 70, which can reduce structural complexity of the frame 1 and the rotating member 40, effectively improve production efficiency of the frame 1 and the rotating member 40, and is conducive to reducing volumes of an end of the frame 1 and an end of the rotating member 40, and can hide a connection part between the two, thereby improving an aesthetic degree of the appearance. In addition, by using the rotating connection assembly 70 independent of the rotating member 40 and the frame 1, damping positioning and the like can be integrated into the rotating connection assembly 70, which facilitates assembly and replacement while ensuring functionality.

In other examples, the rotating member 40 is sleeved with the frame 1, so that the rotating member 40 rotates relative to the frame 1. The rotating member 40 may be sleeved with the frame 1. For example, the frame 1 is provided with a groove structure, and an end of the rotating member 40 is rotatably provided in the groove structure of the frame 1, so that the two are sleeved and the rotating member 40 can rotate relative to the frame 1. Additionally or alternatively, the rotating member 40 is provided with a groove structure on an end and sleeved on an end of the frame 1 so as to be rotatably connected to the frame 1. In this way, the rotation of the rotating member 40 relative to the frame 1 is achieved, and thus a space volume of the connection part between the frame 1 and the rotating member 40 can also be reduced.

Referring back to FIG. 11, in some examples of the present disclosure, an end of the swinging member 50 is connected to the rotating member 40 via the swing shaft S so as to rotate around the swing shaft S to be folded or unfolded. Among them, a connecting groove 41 is provided at the end of the rotating member 40, the connecting groove 41 has an opening located on an end surface of the rotating member 40, the swinging member 50 is inserted into the connecting groove 41 through the opening, and the connecting groove 41 extends toward an inner side surface of the rotating member 40 to form an avoidance gap 43 for the swinging member 50 to rotate.

By accommodating the swinging member 50 in the connecting groove 41, the space volume of the connector 100 can be reduced after the swinging member 50 is connected with the rotating member 40. At the same time, the rotation of the swinging member 50 can be limited via the connecting groove 41 to prevent the swinging member 50 from rotating too much, thereby achieving a certain anti-reversal effect. The swinging member 50 abuts against the inner wall of the connecting groove 41 in the unfolded state and is located at the avoidance gap 43 in the folded state. When rotating from the unfolded state to the folded state, the swinging member 50 can rotate at an angle c (e.g., 80°≤c≤100°).

The swinging member 50 and the connecting member 60 may be connected via the rotating connection assembly 70, and should have the beneficial effects brought by the rotating connection assembly 70, which is not repeated herein. In this example, regarding the connection between the swinging member 50 and the connecting member 60, when the limiting portion 735 abuts against the inner side wall of the first end of the slide groove 71b, the connecting member 60 is located in the third preset position, at which time the orientation of the sound outlet of the headphone unit 300 intersects with the width direction AA of the frame 1. When the limiting portion 735 abuts against the inner side wall of the second end of the slide groove 71b, the connecting member 60 is located in the fourth preset position, at which time the orientation of the sound outlet of the headphone unit 300 is parallel to the width direction AA of the frame 1.

It can be understood that the first preset position and the second preset position are different from the third preset position and the fourth preset position, so that the connecting member 60 can rotate relative to the swinging member 50 at an angle b (e.g., 80°≤b≤100°).

In other examples, the swinging member 40 is sleeved with the connecting member 60 so that the connecting member 60 can rotate relative to the swinging member 40. For example, a mounting groove is provided at one end of the connecting member 60 close to the swinging member 50, and an end of the swinging member 50 away from the rotating member 40 is inserted into the mounting groove, so that the swinging member 50 is sleeved with the connecting member 40, and the connecting member 60 can rotate relative to the swinging member 50. In this way, the swinging member 50 is rotatably connected with the connecting member 60, which can reduce the space volume of the connection part between the two. The end of the swinging member 50 away from the rotating member 40 may be provided with a mounting groove and sleeved on the connecting member 60, so that the connecting member 60 can rotate relative to the swinging member 50, which is not limited by the present disclosure.

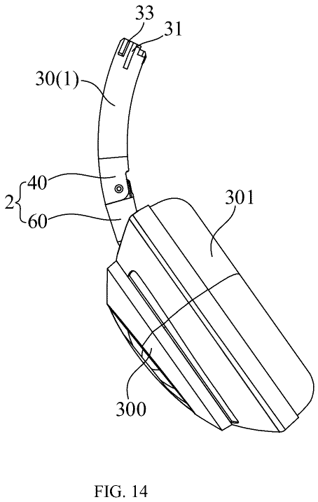

In some examples of the present disclosure, the frame 1 includes a frame body 10 and a sliding member 30. Referring to FIGS. 14 to 16, the frame body 10 is overall arc-shaped, an extending movement channel 13a is provided at the end of the frame body 10, the sliding member 30 is slidably provided in the movement channel 13a, and the rotating member 40 is rotatably connected to an end of the sliding member 30 exposed outside the movement channel 13a. The sliding member 30 is configured to connect the folding assembly 2 and the headphone unit 300 to the frame body 10. When the sliding member 30 slides relative to the frame body 10, the folding assembly 2 and the headphone unit 300 are driven to move together. In order to fit the shape of the frame 1, the movement channel 13a may extend in an arc shape, and the sliding member 30 and the rotating member 40 may be provided in an arc shape to slide smoothly in the movement channel 13a.

Specifically, a guide groove 13b is provided on the side wall of the movement channel 13a, and a first protrusion 31 is provided at the end of the sliding member 30 away from the rotating member 40. The first protrusion 31 extends along the extension direction of the sliding member 30 and is slidably provided in the guide groove 13b. Sliding fit between the first protrusion 31 and the guide groove 13b can provide guidance for the movement of the sliding member 30 relative to the frame body 10 and improve movement stability of the sliding member 30.

To further improve stability, two opposite side walls of the movement channel 13a may be provided with guide grooves 13b, two first protrusions 31 may be respectively provided on two sides of the end of the sliding member 30, and the two first protrusions 31 may be provided in one-to-one correspondence with the two guide grooves 13b.

A second protrusion 33 may be further provided at the end of the sliding member 30 away from the rotating member 40, and the second protrusion 33 is spaced apart from the first protrusion 31. The other side walls of the movement channel 13a are further provided with limiting grooves, in which the second protrusion 33 is slidably provided. When the second protrusion 33 abuts against an inner side wall of one end of the limiting groove, a majority of the sliding member 30 is located in the movement channel 13a; when the second protrusion 33 abuts against an inner side wall of the other end of the limiting groove, a minority of the sliding member 30 is located in the movement channel 13a. The sliding fit between the second protrusion 33 and the limiting groove can prevent the sliding member 30 from detaching from the movement channel 13a on one hand, and can also further improve the movement stability of the sliding member 30 on the other hand.

It can be understood that the sliding member 30 is slidably provided so that the length of the frame 1 can be variably set, thereby improving applicability of the connector 100. In the folded state, most of the sliding member 30 is located in the movement channel 13a, thereby further reducing the volume of the headphones 1000 in storage.

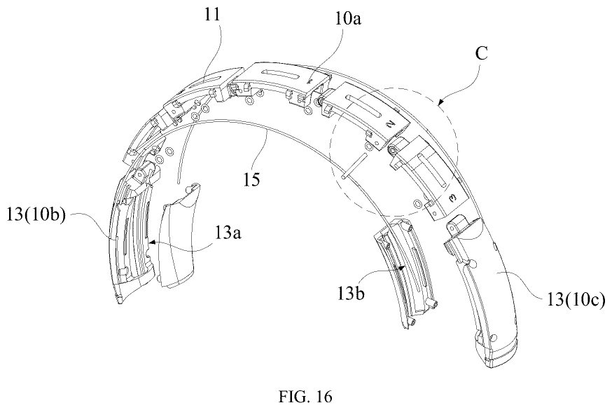

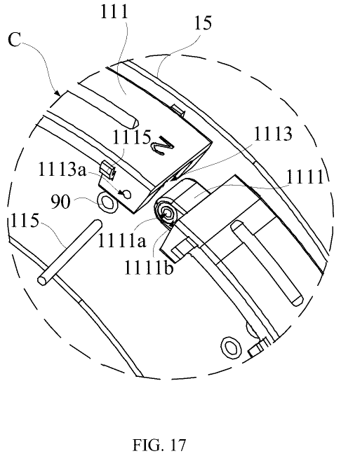

Referring to FIGS. 16 and 17, the frame body 10 includes a plurality of joint structures connected in sequence. Two adjacent joint structures are rotatably connected by at least one rotating shaft 115. A length direction of the rotating shaft 115 is parallel to the width direction AA shown in FIG. 1. The two adjacent joint structures can rotate relatively around one or two opposed rotating shafts 115, so that the frame 1 can switch between the folded state and the unfolded state, thereby increasing or reducing the wearing space 1a.

It can be understood that, taking the connector 100 applied to the headphones 1000 as an example, when the connector 100 is not used, the frame 1 can be folded by rotating the joint structures around the rotating shafts 115 respectively, so that the frame 1 is in the folded state, and thus the connector 100 is in the folded state, and any two adjacent joint structures can rotate relatively around at least one rotating shaft 115, so that multiple areas of the frame 1 can be folded, thereby greatly reducing the space volume of the frame 1 in the folded state and reducing the space volume of the connector 100, making the connector 100 more convenient to carry.

Specifically, referring to FIG. 17, a peg 1111 (e.g., a connector, a plug, a pin) is provided at an end of one of the two adjacent joint structures, protruded at one end of the joint structure and provided with a first through hole passing therethrough along the width direction AA. A rabbet 1113 (e.g., a slot, a socket) is provided at an end of the other joint structure and has an opening toward the peg 1111, and two side walls forming the opening are respectively provided with two second through holes. The peg 1111 enters the rabbet 1113 from the opening and is inserted into the rabbet 1113. At least one rotating shaft 115 passes through the second through hole, the first through hole, and the second through hole in sequence, thereby passing through the side wall of the rabbet 1113 and the peg 1111 to enable the two adjacent joint structures to be rotatably connected.

In the example of the present disclosure, the peg 1111 and the side wall of the rabbet 1113 define a fourth annular groove 1111b provided around the rotating shaft 115. For example, part of a wall surface surrounding the first through hole on the two opposite side walls of the peg 1111 is recessed to form the fourth annular groove 1111b together with the side wall of the rabbet 1113; or, part of a wall surface surrounding the second through hole on the inner side wall of the rabbet 1113 is recessed to form the fourth annular groove 1111b together with the side wall of the peg 1111. The frame 1 further includes an annular damping member 90 filled in the fourth annular groove 1111b. It can be understood that the damping member 90 is made of a material with a certain elasticity such as rubber. When provided in the fourth annular groove 1111b, the damping member 90 can abut against the wall surface of the peg 1111 and the inner side wall of the rabbet 1113 at the same time. When the peg 1111 is stationary relative to the rabbet 1113, the damping member 90 provides a friction force to enable the two adjacent joint structures to maintain the state before stopping rotation, thereby playing a positioning role.

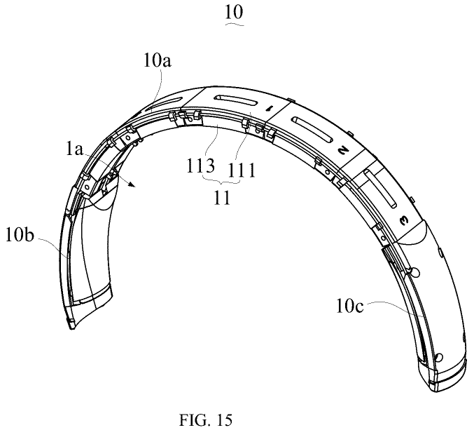

Referring back to FIG. 15, in some examples of the present disclosure, the frame 1 includes a first clamping mechanism 10b, a second clamping mechanism 10c and a connecting mechanism 10a; the second clamping mechanism 10c is provided opposite to the first clamping mechanism 10b; the connecting mechanism 10a is located between the first clamping mechanism 10b and the second clamping mechanism 10c, one end of the connecting mechanism 10a is rotatably connected to the first clamping mechanism 10b through at least one rotating shaft 115, and the other end of the connecting mechanism 10a is rotatably connected to the second clamping mechanism 10c through another at least one rotating shaft 115.

It can be understood that when the connector 100 is worn on the head, the connecting mechanism 10a is located at the top of the head, the first clamping mechanism 10b and the second clamping mechanism 10c are respectively located on two sides of the head, and the connector 100 is fixed on the head via combined clamping forces of the first clamping mechanism 10b and the second clamping mechanism 10c.

The connecting mechanism 10a is formed by connecting a plurality of first joint structures 11 in sequence. The first joint structure 11 includes a joint body 111 and an elastic buffer 113. The joint body 111 is made of an elastic material. Elastic forces of a plurality of joint bodies 111 in the connecting structure can provide a large clamping force for the first clamping mechanism 10b and the second clamping mechanism 10c, so that the connector 100 is firmly connected to the head to prevent the connector 100 from falling off the head; a receiving groove is provided on an inner side of the joint body 111, and the elastic buffer 113 is provided in the receiving groove. The hardness of the material of the elastic buffer 113 is less than the hardness of the joint body 111. The elastic buffer 113 may be sponge, soft silica gel, or the like. By filling the soft elastic buffer 113 in the receiving groove, the overall hardness of the first joint structure 11 may be reduced, thereby reducing pressure on the human's head.

It should be noted that structures of all the first joint structures 11 in the connecting mechanism 10a may be the same or different.

The first clamping mechanism 10b may be formed by connecting a plurality of second joint structures 13 in sequence, and the second clamping mechanism 10c may be formed by connecting a plurality of other second joint structures 13 in sequence. In some other examples, the first clamping mechanism 10b is composed of one independent second joint structure 13. Different from the first joint structure 11, the second joint structure 13 is longer so as to better clamp the head. One end of the second joint structure 13 is rotatably connected to the first joint structure 11 of the connecting mechanism 10a via the rotating shaft 115, and the other end is connected to the folding assembly 2. It is also convenient for the independent second joint structure 13 to provide the movement channel 13a, so that the sliding member 30 is slidably provided in the movement channel 13a, and the sliding member 30 is connected to the folding assembly 2 so as to achieve telescopic adjustment of the headphone unit 300. It can be understood that the second clamping mechanism 10c is independently composed of another second joint structure 13.

As shown in FIGS. 16 and 17, in an example of the present disclosure, a memory metal strip 15 is provided on the side of the frame 1, is connected to the frame 1 and has a similar shape to the frame 1, and the frame 1 maintains an unfolded state under the action of the memory metal strip 15. Among them, a preparation material of the memory metal strip 15 may be nickel-titanium alloy. The memory metal has performances to remember the original shape and to return to the original shape under certain conditions after the shape changes. In the example of the present disclosure, by providing the memory metal strip 15 on the side of the frame 1, the original shape of the memory metal strip 15 can be designed to be the same as or close to the shape of the frame 1 in the unfolded state, so that the memory metal strip 15 can provide a certain restoring force when the connector 100 is restored to the unfolded state. The original shape of the memory metal strip 15 can also be designed to be the same as the shape of the frame 1 in the folded state, so that the memory metal strip 15 can provide the connector 100 with a restoring force to return to the folded state after the connector 100 is in the unfolded state, thereby making the connector 100 have a greater clamping force when worn on the head. A specific working principle of memory metal has been disclosed in the related art, and is not repeated in this disclosure.

Further, the memory metal strip 15 may be provided on only one side of the frame 1, or may be provided on both sides of the frame 1.

Specifically, in an example of the present disclosure, a plurality of mounting members 1115 (e.g., clips, brackets, slots, or fasteners) are provided on the frame 1, are arranged at intervals on the frame 1, and define a mounting channel through which the memory metal strip 15 passes. The memory metal strip 15 is limited by the mounting channel to prevent the memory metal strip 15 from being separated from the frame 1.

The above are specific implementation structures of the connector 100 of the examples of the present disclosure. The headphones 1000 of the present disclosure adopt some or all the technical solutions of all the above examples, and thus at least have some or all the effects brought by the technical solutions of the above examples, which will not be repeated here.

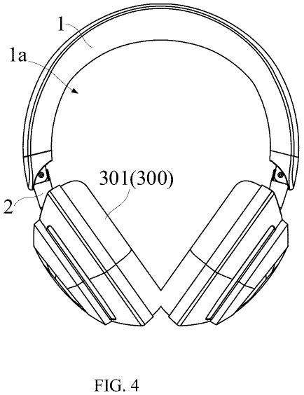

Referring to at least FIG. 4 to FIG. 10, the present disclosure describes an example of the headphones 1000 as follows:

The headphones 1000 include a connector 100 and two headphone units 300. The connector 100 includes a frame 1 and two folding assemblies 2. The frame 1 is in an arc shape overall. The two folding assemblies 2 are respectively connected to two ends of the frame 1. One of the headphone units 300 is connected to one of the folding assemblies 2, and the other of the headphone units 300 is connected to the other of the folding assemblies 2.

The frame 1 includes a frame body 10 and a sliding member 30. The frame body 10 is in an arc shape overall and is composed of a plurality of joint structures connected in sequence, so that the frame body 10 has a folded state and an unfolded state. A movement channel 13a is provided at an end of the frame body 10, the sliding member 30 is slidably provided in the movement channel 13a, and the folding assembly 2 is rotatably connected to an end of the sliding member 30 exposed outside the movement channel 13a.

The folding assembly 2 includes a rotating member 40, a swinging member 50 and a connecting member 60. The rotating member 40 is connected to the sliding member 30, and the rotating member 40 can rotate relative to the sliding member 30 at an angle a, (e.g., 15°≤a≤35°). The swinging member 50 is swingingly connected to an end of the rotating member 40 away from the sliding member 30, and the swinging member 50 can rotate around the swing shaft S at an angle b, so that an end of the swinging member 50 away from the rotating member 40 swings close to or away from the wearing space 1a, thereby switching between the folded state and the unfolded state, the angle b being, for example, 80°≤b≤100°; the connecting member 60 is configured to connect the headphone unit 300 and to the end of the swinging member 50 away from the rotating member 40, and can rotate relative to the swinging member 50 at an angle c (e.g., 80°≤c≤100°).

The headphones 1000 may have one or more folded states and an unfolded state.

In the unfolded state, the frame body 10 is in the unfolded state, most of the sliding member 30 extends out of the movement channel 13a, the rotating member 40 is located at the first preset position, the swinging member 50 is in the unfolded state, and the connecting member 60 is located at the third preset position. The orientation of the sound outlet of the headphone unit 300 may intersect with the width direction AA of the frame 1, as shown in FIG. 4.

In the storage state, the frame body 10 may be in a folded state, and most of the sliding member 30 may be located in the movement channel 13a, the rotating member 40 may be located in the second preset position, the swinging member 50 may be in the folded state, and the connecting member 60 is located in the fourth preset position. The two headphone units 300 are located in the wearing space 1a, and the two earmuffs 301 may be provided close to each other, and the headphone units 300 are provided at an angle d with the plane where the frame 1 is in, as shown in FIG. 10.

The same or similar reference numbers in the drawings of examples of the present disclosure correspond to the same or similar parts. In the description of the present disclosure, it is to be understood that the terms “upper”, “lower”, “left”, “right”, and the like indicating relationships of directions and positions are based on relationships of directions and positions shown in the drawings, and are intended to be illustrative and simplify descriptions only and not to indicate or imply that the referred device or element must be provided in a particular direction, configured and operated in a particular direction. Therefore, the terms used to describe relationships of positions are intended to be illustrative only and are not intended to limit the present disclosure. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be included in the scope of the disclosure.

What is claimed is:

1. A headband comprising:
a frame in an arc shape covering a wearing space for the headband; and
two folding assemblies, wherein the two folding assemblies are respectively connected to two ends of the frame, and each of the two folding assemblies comprises:
a pivot connected to the frame and configured to rotate relative to the frame;
an arm connected to the pivot and configured to swing toward or away from the wearing space; and
a rotating connector connected to the arm and configured to rotate relative to the arm.

2. The headband according to claim 1, further comprising:
a rotating connection assembly comprising a socket and a plug, wherein the socket and the plug are configured to fit with each other and rotate relative to each other; and
one of the pivot and the frame is connected to the socket, and the other one of the pivot and the frame is connected to the plug.

3. The headband according to claim 2, wherein:
the socket comprises a connecting channel,
an inner wall of the connecting channel comprises an arc-shaped slide groove extending along a circumference of the connecting channel,
a part of the plug extending into the connecting channel comprises a stopper slidably provided in the slide groove, and
the stopper is abutted and limited by an inner side wall of one end of the slide groove.

4. The headband according to claim 3, wherein:
the part of the plug extending into the connecting channel comprises an inserting shaft connected to the stopper,
the rotating connection assembly further comprises an annular damping device,
an outer circumferential wall of the inserting shaft and the inner wall of the connecting channel fit and define a first annular groove,
the first annular groove extends along a circumference of the inserting shaft, and
the annular damping device is filled in the first annular groove.

5. The headband according to claim 4, wherein:
an outer circumferential wall of the inserting shaft comprises a second annular groove, and the inner wall of the connecting channel comprises a third annular groove,
the second annular groove is connected to the third annular groove to form a mounting annular groove which extends along a circumference of the inserting shaft, and
the rotating connection assembly further comprises an arc-shaped clamp provided in the mounting annular groove.

6. The headband according to claim 1, further comprising:
a connecting groove located at an end of the pivot and has an opening located on an end surface of the pivot,
the arm is inserted into the connecting groove through the opening, and
the connecting groove extends toward an inner side surface of the pivot to form a gap for the arm to rotate.

7. The headband according to claim 1, wherein the frame comprises:
a frame body in an arc shape overall, wherein an end of the frame body comprises a movement channel; and
a slide in the movement channel, wherein the pivot is rotatably connected to an end of the slide exposed outside the movement channel.

8. The headband according to claim 7, wherein:
a guide groove is provided on a side wall of the movement channel, and
a first protrusion is provided at an end of the slide away from the pivot, extends along an extension direction of the slide, and is slidably provided in the guide groove.

9. The headband according to claim 1, wherein:
the frame comprises a plurality of joint structures connected in sequence,
two of the plurality of joint structures are rotatably connected by at least one of rotating shafts, and
the two of the plurality of joint structures are configured to rotate relatively around the at least one of rotating shafts.

10. The headband according to claim 9, wherein:
a peg is provided at an end of one of the two of the plurality of joint structures,
a rabbet is provided at an end of the other one of the two of the plurality of joint structures, and
the peg is inserted into the rabbet, and the at least one of the rotating shafts passes through a side wall of the rabbet and the peg.

11. The headband according to claim 10, wherein:
the frame further comprises an annular damping device,
the peg and the side wall of the rabbet define a fourth annular groove provided around the at least one of rotating shafts, and
the damping device is filled in the fourth annular groove.

12. The headband according to claim 9, wherein the frame comprises:
a first clamping mechanism;
a second clamping mechanism provided opposite to the first clamping mechanism; and
a connecting mechanism between the first clamping mechanism and the second clamping mechanism, wherein:
one end of the connecting mechanism is rotatably connected to the first clamping mechanism through the at least one of the rotating shafts, and the other end of the connecting mechanism is rotatably connected to the second clamping mechanism through another at least one of the rotating shafts,
the plurality of the joint structures comprise first joint structures and second joint structures,
the connecting mechanism is formed by connecting the first joint structures in sequence,
the first clamping mechanism comprises at least one of the second joint structures, and
the second clamping mechanism comprises another one of the second joint structures.

13. The headband according to claim 12, wherein one of the first joint structures comprises:
a joint body comprising a receiving groove; and
an elastic buffer in the receiving groove.

14. The headband according to claim 1, further comprising:
a memory metal strip located on a side of the frame and connected to the frame, and the frame maintains an unfolded state under an action of the memory metal strip.

15. The headband according to claim 14, wherein a plurality of mounting members are provided on the frame, are arranged at intervals on the frame, and define a mounting channel through which the memory metal strip passes.

16. Headphones comprising:
two speakers;
a frame in an arc shape covering a wearing space;
a first pivot connected to the frame and configured to rotate relative to the frame;
a movable arm connected to the first pivot and configured to move one of the two speakers toward or away from the wearing space; and
a second pivot connected to the movable arm and the one of the two speakers, and is configured to rotate relative to the movable arm.

17. The headphones according to claim 16, wherein:
the second pivot further comprises a rotating connection assembly,
the rotating connection assembly comprising a socket and a plug that fit with each other and rotate relative to each other, and
one of the first pivot and the frame is connected to the socket, and the other one of the first pivot and the frame is connected to the plug.

18. The headphones according to claim 16, further comprising:
a third pivot connected to the frame and configured to rotate relative to the frame;
a second movable arm connected to the third pivot and configured to move another one of the two speakers toward or away from the wearing space; and
a fourth pivot connected to the movable arm and the another one of the two speakers, and is configured to rotate relative to the movable arm.

19. The headphones according to claim 18, further comprising:
a first earmuff attached to the one of the two speakers, and
a second earmuff attached to the another one of the two speakers, wherein:
the first earmuff is in contact with the second earmuff in response to movement of the movable arm and the second movable arm toward the wearing space, and rotation of the second pivot and fourth pivot.

20. A headband comprising:
a frame in an arc shape covering a wearing space;
a first pivot connected to the frame and configured to rotate relative to the frame;
a movable arm connected to the first pivot and is configured to move toward or away from the wearing space; and
a second pivot connected to the movable arm and configured to rotate relative to the movable arm.
